(19) United States
(12) Patent Application Publication
(10) Pub. No.: US 2025/0050678 A1
(43) Pub. Date: Feb. 13, 2025

(54) SMART CARD CASE WITH SOFTWARE INTEGRATION FOR ORGANIZATION, LOCATION TRACKING, AND PROTECTION OF COLLECTIBLES SECURED THEREIN

(71) Applicant: Brian Neil Katz, Boynton Beach, FL (US)

(72) Inventor: Brian Neil Katz, Boynton Beach, FL (US)

(21) Appl. No.: 18/652,900

(22) Filed: May 2, 2024

Related U.S. Application Data
(60) Provisional application No. 63/518,205, filed on Aug. 8, 2023.

(51) Int. Cl. G06Q 10/0875; B42F 7/14; E05B 65/52; G01K 1/024; G01K 3/00; G09F 9/30

(52) U.S. Cl. CPC B42F 7/145; G01K 1/024; G06Q 10/087; B42P 2221/02; G06Q 10/0875

(57) ABSTRACT

A smart card case with software integration for organization, digital management and location, and protection of a plurality of collectibles secured therein. The smart card case provides a plurality of collectible storage areas, each storage area configured to store one collectible of the plurality of collectibles. A light indicator is operatively associated with each storage area so that the light indicator moves between an activated state and a deactivated state when a collectible occupies or is absent from the collectible storage area, respectively. Each collectible may have a readable identifier configured to be read by a mobile computing device loaded with the systemic software so that the plurality of characteristics of the collectible is remotely trackable by way of the software. The systemic software also identifies captured images of collectibles to identify them and prompt users for additional characteristics and parameters which are managed by the software.

### CROSS-REFERENCE TO RELATED APPLICATION

This application claims the benefit of priority of U.S. provisional application No. 63/518,205, U.S. provisional application number filed 8 Aug. 2023, the contents of which are herein incorporated by reference.

### BACKGROUND OF THE INVENTION

The present invention relates to safeguarding and organizing collectibles and, more particularly, to a smart card vault or case with software integration for easy organization, location tracking, and protection of the collectibles secured therein.

Many collectibles, such as trading cards (or collectible cards) or comic books are fragile by nature and made out of paper products and so degrade over time when exposed in an unprotected manner. Thus, collectors of such collectibles tend to store their wares in transparent sleeves or the like. Serious collectors have their collectibles graded, and then shielded in graded slabs, which provide substantial protection as well as enable the grade or indicia thereof to be operatively associated with the protected collectible.

Since graded collectible slabs look very similar to each other, when such slabs are stacked, so one can only see the edges of the collectible, it is hard to discern which collectible is in which slab when there are multiple slabs stacked on top of each other. Likewise, quickly identifying and organizing a multitude of slabs is a challenge avid collectors face in addition to preventing these valuable commodities from thievery.

The purpose of the present invention is to address the challenge of efficiently organizing, locating, and protecting valuable graded sports card slabs, ensuring ease of access and accurate inventory management for collectors.

Existing devices and systems in the field lack the ability to effectively organize, track, manage, and secure graded collections, leading to organizational inefficiencies, (manual) inventory management inaccuracy, and limited protection through weak security measures, whereas the present invention, colloquially known as the “Hobby Smart Case” revolutionizes the experience by providing comprehensive digital management, enhanced security features, and seamless integration with a mobile app, addressing these critical limitations.

### SUMMARY OF THE INVENTION

The present invention revolutionizes the organization, location tracking, and protection of graded sports card slabs. With its innovative design and integrated technology, the case allows collectors to securely store their cards while providing real-time inventory management through a mobile app. The case embodied in the present invention provides smart features, such as LED indicator lights, streamline card identification and location tracking, thereby ensuring easy access and efficient management of the card collection.

The present invention embodies a smart card case with software integration, wherein the software or mobile app utilizes the following technology in the combination of optical character recognition (OCR) and image recognition, often powered by artificial intelligence (AI) or machine learning (ML) algorithms. This technology is used to capture images of sports cards through a mobile phone (iPhone or Android) and match them to a database for identification.

In practical applications, this might involve the following steps: Image Capture: Using the camera of a mobile device to capture an image of the sports card. Image Processing: Processing the image to detect and isolate key features such as text, logos, and other identifiable markers. OCR Technology: Applying OCR to extract text from the card, which might include the player's name, team, stats, and other relevant information. Image Recognition: Using image recognition algorithms to analyze the visual content of the card (like the player's image, team logo, etc.) to further assist in identification. Database Matching: Comparing the extracted features and text against a database to find a match and identify the card. In some embodiments, card slabs can be additionally scanned by the QR code on PSA slabs only where the same card details can be captured by the mobile app and a specific case and individual card slot assigned. Alternately, stickers with QR Codes can also be applied to slabs as an additional way to inventory the cards.

The present invention may include a weather sensor for temperature and humidity threshold determination, wherein an alert is transmitted via a mobile application when a temperature or humidity setting is below/above a predefined range. The present invention may include a sensor feature notifying when the case top is opened or closed with an alert transmitted via the mobile application. Another feature of the system embodied in the present invention, via the mobile application, is that multiple cases can be added to the application to manage, track, locate and protect each of these cases, wherein each case can be physically located in multiple locations.

The smart vault case of the present invention is an innovative breakthrough, distinct from existing cases, as it incorporates cutting-edge features like LED indicator lights, barcode scanning, and mobile app integration, providing collectors unmatched convenience, security, and real-time tracking capabilities for their graded sports card collection, a level of functionality not found in any other available case.

The present invention is unique in the field by introducing a smart hobby card box that combines advanced technology, such as LED indicators, mobile app integration, and barcode scanning, to offer seamless organization, real-time inventory tracking, enhanced security, and a user-friendly experience for collectors to showcase, manage, and protect their prized graded sports cards.

In one aspect of the present invention, a system for managing a plurality of collectibles that are each assigned a scannable code, wherein the scannable code provides a plurality of characteristics of the collectible, the system providing the following: a container including: a plurality of collectible storage areas, each storage area configured to store one collectible of the plurality of collectibles; and a light indicator operatively associated with each collectible storage area, so that the light indicator moves between an activated state and a deactivated state when one of the plurality of collectibles occupies and does not occupy the collectible storage area, respectively, wherein each scannable code is configured to be read by a mobile computing device loaded with a systemic software so that the plurality of characteristics is remotely trackable by way of the mobile computing device.

In another aspect of the present invention, the system embodied in the present invention further includes the following: a lid that moves between an open condition and a closed condition, wherein the closed condition defines an enclosed space housing the plurality of collectible storage areas, and wherein a condition sensor directly connected to the container exports a condition indication to the mobile computing device by way of the systemic software, wherein the condition indication indicates the open condition and the closed condition; a display unit along an inner surface of the lid, wherein the display unit is operatively associated with the systemic software to display the plurality of characteristics of each scanned scannable code; a climatic sensor configured to determine a temperature and a humidity of the enclosed space, wherein the climatic sensor is configured to export the temperature and humidity to the mobile computing device by way of the systemic software; an electrical port along a body of the container, wherein the electrical port enables electrical power for each light indicator, the display unit, the climatic and condition sensors, wherein the closed condition of the lid is movable between a locked condition and an unlocked condition by way of a lock mechanism; a hibernate mode configured to conserve the electrical power by turning off the light indicators when the container is in the closed condition; a global positioning system configured to identify a global position of the container so that a representation of the global position is representable along a user interface of the mobile computing device, and wherein the systemic software is configured to remotely track the plurality of characteristics of a plurality of containers.

In still yet another aspect of the present invention, a system for managing a plurality of collectibles provides the following: a container including: a plurality of collectible storage areas, each storage area configured to store one collectible of the plurality of collectibles; and a light indicator operatively associated with each collectible storage area, so that the light indicator moves between an activated state and a deactivated state when one of the plurality of collectibles occupies and does not occupy the collectible storage area, respectively, a systemic software integrated with the container, wherein the systemic software is configured to receive an image of each of the plurality of collectibles and, from a systemic database, identify a plurality of characteristics associated with a respective collectible so that each collectible is remotely trackable by way of a mobile computing device on which the systemic software is loaded, wherein the systemic software is configured upon the reading of the readable identifier, to prompt the mobile computing device to add collectible parameters for the collectible, and wherein the systemic software is configured to prompt mobile computing device to place the respective collectible in a specific storage area of the plurality of storage areas.

These and other features, aspects and advantages of the present invention will become better understood with reference to the following drawings, description, and claims.

### BRIEF DESCRIPTION OF THE DRAWINGS

FIG. 1 is a perspective view of an exemplary embodiment of the present invention.

FIG. 2 is a detailed perspective view of a rear side of an exemplary embodiment of the present invention.

FIG. 3 is a perspective view of an exemplary embodiment of the present invention, shown in an open condition.

FIG. 4 is a detailed top plan view of an exemplary embodiment of the present invention.

FIG. 5 is an exploded perspective view of an exemplary embodiment of the present invention, shown in use, illustrating a QR code 32 operatively associated with a graded card 26A (wherein the QR code 32 is located along the back of the graded card 26A).

FIG. 6 is an exploded perspective view of an exemplary embodiment of the present invention, illustrating the electronics thereof.

FIG. 7 is a perspective view of an exemplary embodiment of the present invention pertaining to non-sports cards slabs, including but not limited to comic book slabs.

FIG. 8 is a block diagram of a general and/or special purpose computer 36, which may be a general and/or special purpose computing device, according to some example embodiments of the invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Referring to FIG. 1, the present invention provides a smart vault case 10, 40 for organizing, tracking, managing, and securing a collection of grade-slabbed collectibles 26B, 34. The smart vault case 10, 40 provides sturdy and protective enclosure designed to hold and display the collection of grade-slabbed collectibles 26B, 34. The smart vault case 10, 40 provides a case lid 12A, 42A pivotably connected to the case base 12B, 42B, respectively, for moving the smart vault case 10, 40 between a closed condition and an open condition. In the closed condition, a locking mechanism 16, 46 is provided for moving the smart vault case 10, 40 between an unlocked engagement and a locked engagement preventing the case lid 12A, 42A from separating from the case base 12B, 42B. The locking mechanism 16, 46 may be a combination lock or other security feature to secure the case and protect the cards. The smart vault case 10, 40 may provide a handle 14, 44.

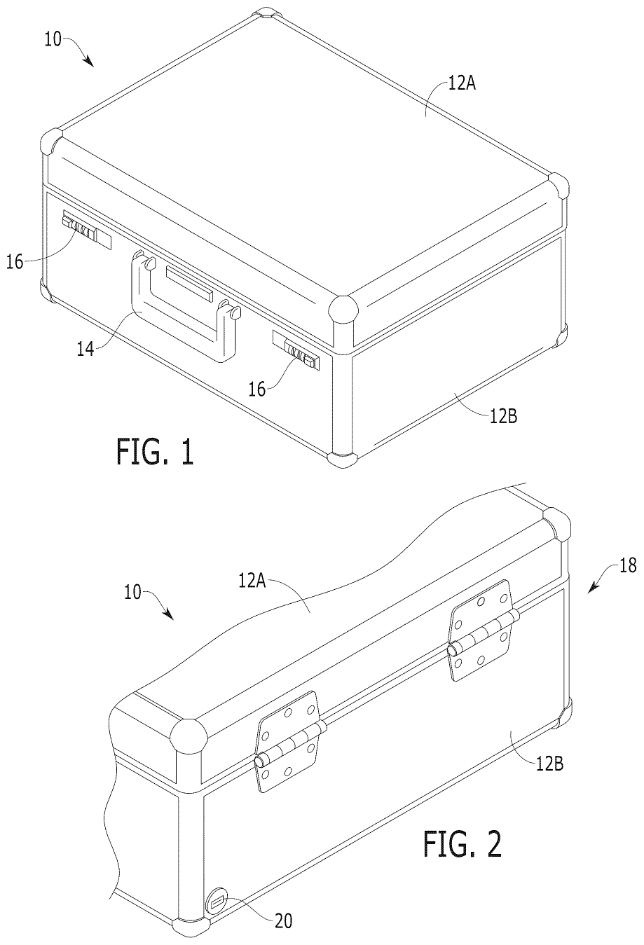

Referring to FIG. 2, a rear side 18, 48 of the smart vault case 10 may provide (though in other embodiment, other sides of the smart vault case 10, 40 may provide) one or more electrical ports 20. The electrical port 20 may enable a power supply to electrically connect, via an internal power cable 38, with the systemic hardware (the hardware being described in more detail below). The electrical port 20 may be a USB-C connection. Some embodiments of the present invention may provide a battery for powering the present invention, wherein the electrical ports 20 may enable electronic data to flow into and out of a computer 36 and the systemic hardware of the present invention.

The computer 36 may include without limitation a processor device 530, a main memory 535, and an interconnect bus 537. The processor device 530 may include without limitation a single microprocessor or may include a plurality of microprocessors for configuring the computer 36 as a multi-processor system. The main memory 535 stores, among other things, instructions and/or data for execution by the processor device 530. The main memory 535 may include banks of dynamic random-access memory (DRAM), as well as cache memory.

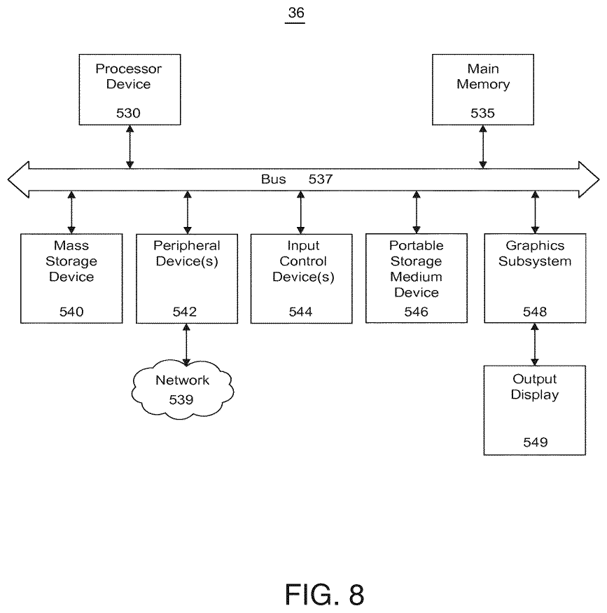

The computer 36 may further include a mass storage device 540, peripheral device(s) 542, non-transitory storage medium device(s) 546, input control device(s) 544, a graphics subsystem 548, and/or a display 549. For explanatory purposes, all components in the computer 36 are shown in FIG. 8 as being coupled through the bus 537. However, the computer 36 is not so limited. Devices of the computer 36 may be coupled through one or more data transport means. For example, the processor device 530 and/or the main memory 535 may be coupled through a local microprocessor bus. The mass storage device 540, peripheral device(s) 542, portable storage medium device(s) 546, and/or graphics subsystem 548 may be coupled via one or more input/output (I/O) buses. The mass storage device 540 may be a nonvolatile storage device for storing data and/or instructions for use by the processor device 530. The mass storage device 540 may be implemented, for example, with a magnetic disk drive or an optical disk drive. In a software embodiment, the mass storage device 540 is configured for loading contents of the mass storage device 540 into the main memory 535.

The portable storage medium device 546 operates in conjunction with a nonvolatile portable storage medium, such as, for example, a compact disc read only memory (CD-ROM), to input and output data and code to and from the computer 36. In some embodiments, the software for storing information may be stored on a portable storage medium and may be inputted into the computer 36 via the portable storage medium device 546. The peripheral device(s) 542 may include any type of computer support device, such as, for example, an input/output (I/O) interface configured to add additional functionality to the computer 36. For example, the peripheral device(s) 542 may include a network interface card for interfacing the computer 36 with a network 439.

The input control device(s) 544 provides a portion of the user interface for a user of the computer 36. The input control device(s) 544 may include a keypad and/or a cursor control device. The keypad may be configured for inputting alphanumeric characters and/or other key information. The cursor control device may include, for example, a handheld controller or mouse, a trackball, a stylus, and/or cursor direction keys. To display textual and graphical information, the computer 36 may include the graphics subsystem 548 and the output display 549. The output display 549 may include a cathode ray tube (CRT) display and/or a liquid crystal display (LCD). The graphics subsystem 548 receives textual and graphical information and processes the information for output to the output display 549.

Each component of the computer 36 may represent a broad category of a computer component of a general and/or special purpose computer. Components of the computer 36 are not limited to the specific implementations provided here. The computer 36 is operatively associated with a cloud-based or non-cloud-based card slab database for retrievably storing data via the mobile app 22.

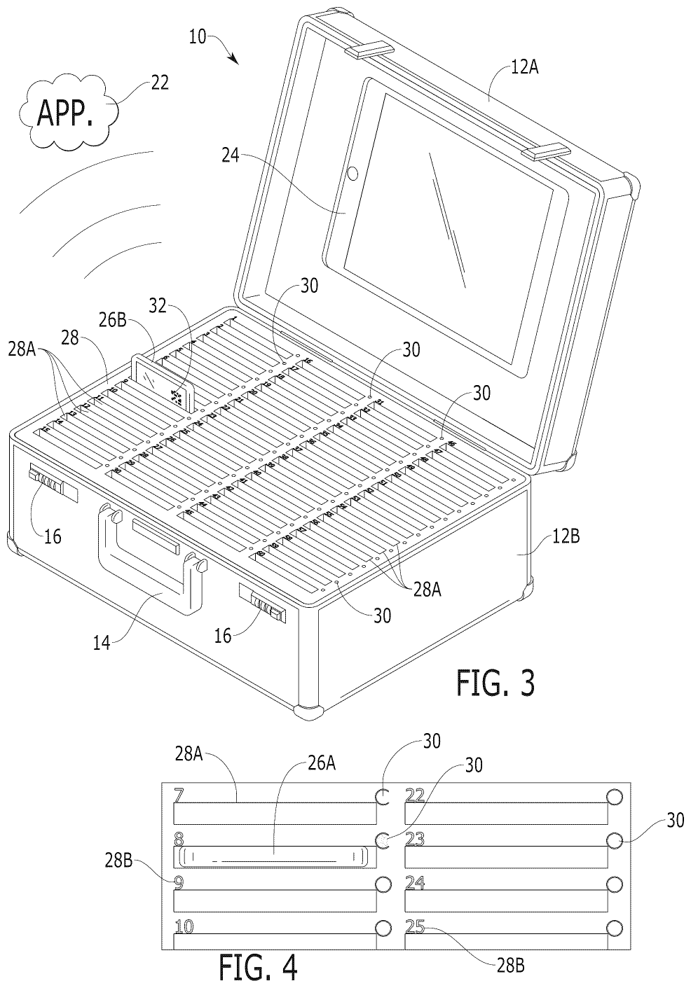

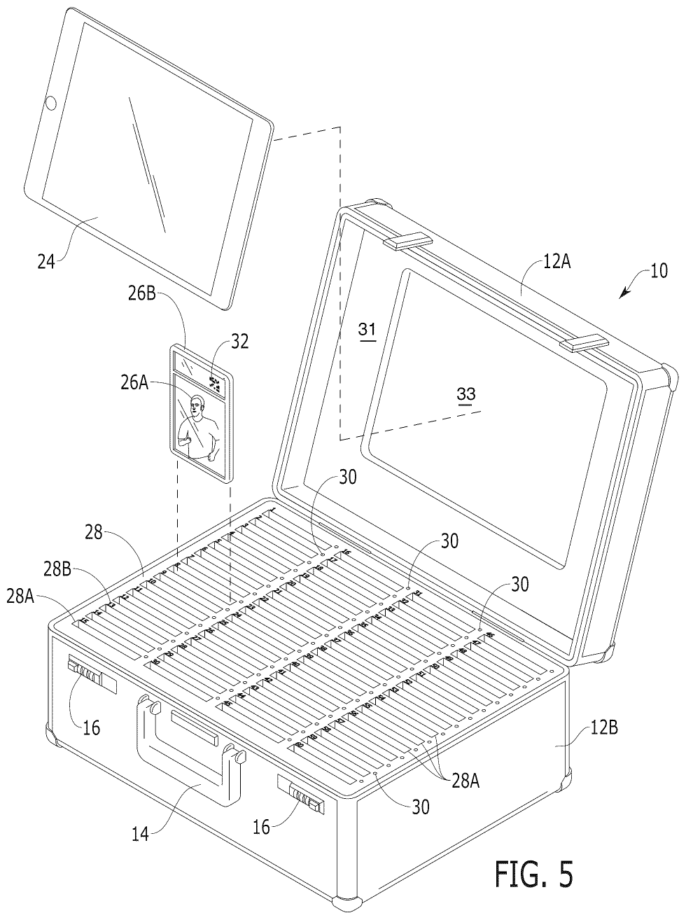

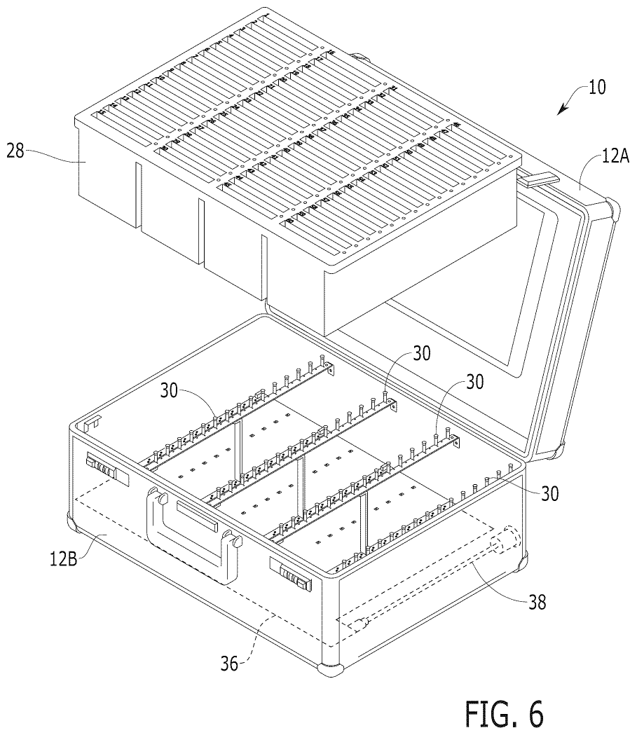

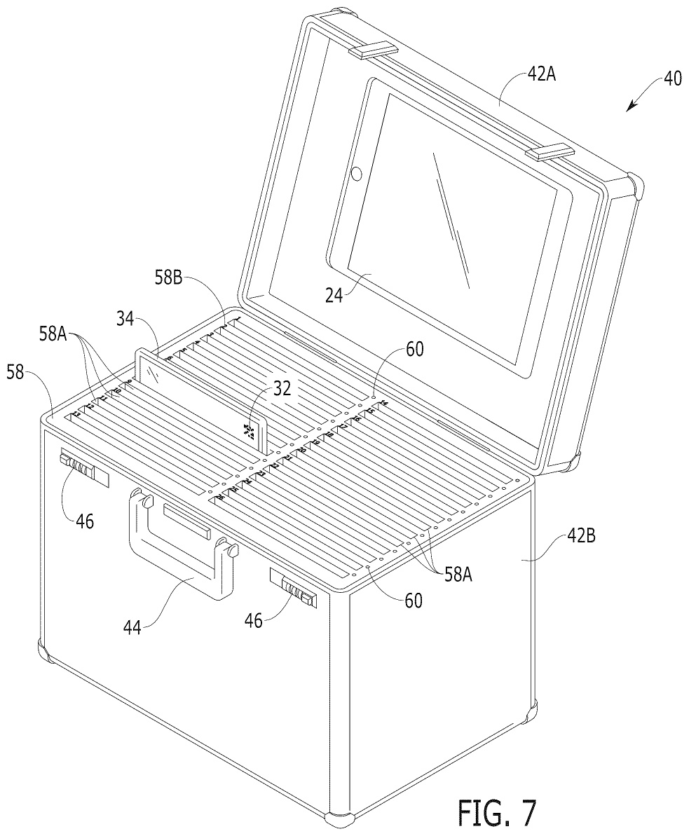

Referring to FIGS. 3-7, the smart vault case 10 defines an internal compartment dimensioned and shaped to accommodate a case insert 28, 58. The case insert 28, 58 provides a plurality of slots 28A, 58A, each slot 28A, 58A dimensioned and adapted for slidably receiving a card slab 26B or comic book slab 56A. Adjacent to each slot 28A, 58A is an indicator 30, 60, and a separate numerical indicia 28B, 56B, respectively. Each slot 28A, 58A securely holds the graded collectible 26A, organized in columns and rows. The indicators 30, 60 may be, but is not limited to, LED lights positioned next to each slot 28A, 58A to provide visual feedback upon card insertion, removal, and other actions. Each numerical indicia 28B, 56B may assign a case serial number for easy identification and tracking.

A systemic/organizational software application (SOSA) 22 is operatively associated with the computer 36 and configured to be responsible for controlling the indicators 30, 60. The SOSA 22 integrates with the smart vault case 10 (making it ‘smart’) allowing collectors to manage their card inventory, track locations, and interact with the LED indicators. Bluetooth/Wi-Fi or other wireless modules enable wireless communication between the smart vault case 10 and SOSA 22.

Each graded collectible 26A may provide a readable barcode or QR code 32 which can be scanned by an image capturing device having scanning/decoding functionality, e.g., a mobile phone camera (iPhone and Android), to identify the details of the graded card within each slab. Not all graded card slabs 26A have a QR code or other bar code. Some graded card slabs do not have a QR code or other barcode. The mobile application 22 is enabled to scan the surface of the entire card and match against a database of graded cards across all grading companies to match the card being captured by the image capturing device operatively associated with the software application 22. Via the software application 22, a user may be prompted to confirm the card identified within the lookup or manually search the database, or key in manual card details when not automatically found. The barcodes 32 may be stickers with unique identifiers to label and identify each card and facilitate optical automatic card recognition.

The smart vault case 10 may provide display unit 24 either integrated into the unit or akin to an iPad mini or smartphone, to show card details, inventory, and other information.

The SOSA 22 operatively associates with a network which may refer to any interconnecting system capable of transmitting audio, video, signals, data, messages, or any combination of the preceding. The network may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

The server and the computer of the present invention may each include computing systems. This disclosure contemplates any suitable number of computing systems. This disclosure contemplates the computing system taking any suitable physical form. As example and not by way of limitation, the computing system may be a virtual machine (VM), an embedded computing system, a system-on-chip (SOC), a single-board computing system (SBC) (e.g., a computer-on-module (COM) or system-on-module (SOM)), a desktop computing system, a laptop or notebook computing system, a smart phone, an interactive kiosk, a mainframe, a mesh of computing systems, a server, an application server, or a combination of two or more of these. Where appropriate, the computing systems may include one or more computing systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing systems may perform at different times or at different locations one or more steps of one or more methods described or illustrated herein, where appropriate.

The SOSA 22 contemplates software embodiments presented herein may be a computer program product, or software, that may include an article of manufacture on a machine-accessible or machine-readable medium having instructions. The instructions on the non-transitory machine-accessible machine-readable or computer-readable medium may be used to program a computer system or other electronic device. The machine- or computer-readable medium may include, but is not limited to, floppy diskettes, optical disks, CD-ROMs, and magneto-optical disks or other types of media/machine-readable medium suitable for storing or transmitting electronic instructions. The techniques described herein are not limited to any particular software configuration. They may find applicability in any computing or processing environment. The terms “computer-readable”, “machine-accessible medium” or “machine-readable medium” used herein shall include any medium that is capable of storing, encoding, or transmitting a sequence of instructions for execution by the machine and that causes the machine to perform any one of the methods described herein. Furthermore, it is common in the art to speak of software, in one form or another (e.g., program, procedure, process, application, module, unit, logic, and so on), as taking an action or causing a result. Such expressions are merely a shorthand way of stating that the execution of the software by a processing system causes the processor to perform an action to produce a result.

Portions of the example embodiments of the invention may be conveniently implemented by using a conventional general-purpose computer, a specialized digital computer and/or a microprocessor programmed according to the teachings of the present disclosure, as is apparent to those skilled in the computer art. Appropriate software coding may readily be prepared by skilled programmers based on the teachings of the present disclosure.

Some embodiments may also be implemented by the preparation of application-specific integrated circuits, field programmable gate arrays, or by interconnecting an appropriate network of conventional component circuits.

Some embodiments include a computer program product. The computer program product may be a storage medium or media having instructions stored thereon or therein which can be used to control, or cause, a computer to perform any of the procedures of the example embodiments of the invention. The storage medium may include without limitation a floppy disk, a mini disk, an optical disc, a Blu-ray Disc, a DVD, a CD or CD-ROM, a micro-drive, a magneto-optical disk, a ROM, a RAM, an EPROM, an EEPROM, a DRAM, a VRAM, a flash memory, a flash card, a magnetic card, an optical card, nano-systems, a molecular memory integrated circuit, a RAID, remote data storage/archive/warehousing, and/or any other type of device suitable for storing instructions and/or data.

Stored on any one of the computers readable medium or media, some implementations include software for controlling both the hardware of the general and/or special computer or microprocessor, and for enabling the computer or microprocessor to interact with a human user or other mechanism utilizing the results of the example embodiments of the invention. Such software may include without limitation device drivers, operating systems, and user applications. Ultimately, such computer readable media further includes software for performing example aspects of the invention, as described above.

Included in the programming and/or software of the general and/or special purpose computer or microprocessor are software modules for implementing the procedures described above.

While various example embodiments of the present invention have been described above, it should be understood that they have been presented by way of example, and not limitation. It will be apparent to people skilled in the relevant art(s) that various changes in form and detail can be made therein. Thus, the present invention should not be limited by any of the above-described example embodiments but should be defined only in accordance with the following claims and their equivalents.

In addition, it should be understood that the accompanying figures are presented for example purposes only. The architecture of the example embodiments presented herein is sufficiently flexible and configurable, such that it may be utilized and navigated in ways other than that shown in the accompanying figures. Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

The SOSA 22 may embody a sleep/hibernate mode or module configured to have feature that conserves power and turns off LED indicators 30, 60 when the case is closed, activating them when the smart vault case 10, 40 is in the open condition.

The SOSA 22 may provide a multiple case support module configured to manage and track multiple cases within the SOSA 22 for collectors with larger collections.

The smart vault case 10, 40 serves as the enclosure and foundation for all other components. It houses the graded card slots and provides physical protection for the cards. Within the graded card slots, the individual cards are securely held and organized. Each slot is associated with an LED Indicator that provides visual feedback. The LED indicators 30/60 are connected to a controller, which controls the LED lights, receiving signals from the SOSA 22 via the Bluetooth/Wi-Fi Module.

The SOSA 22 communicates with the computer 36 through the Bluetooth/Wi-Fi module. It allows users to manage their card inventory, track card locations, and send commands to activate specific LED Indicators based on user interactions.

Specifically, the SOSA 22 is configured to receive a captured image (by way of the user's mobile device running SOSA 22) of a graded card 26A, wherein the captured image is compared to a database, a lookup table, array indexing operation, or the like of millions of cards and prompts the user if an identified graded card 26A is correct. Alternatively, SOSA 22 can enable a user to identify the captured image of the graded card 26A via a searchable database. SOSA 22 enables a user to associate the identified graded card 26A to a predetermined collection.

When properly identified, SOSA 22 is also configured to prompt the user to add grading service, grade of card, card details, collection details such as data acquired, source of purchase, and other collectible parameters/characteristics.

SOSA 22 is also configured to prompt the user to add the identified graded card 26A to a chosen case 10 and card slot 28A.

SOSA 22 prompts a user to set notifications of case opening, temperature, measurement, and theme style.

SOSA 22 provides a dashboard, visual representation, and data metrics and management module for each identified card slab 26A each case 10 of a plurality of cases 10, wherein carb slabs 26A can be identified through the dashboard on the display 24 or the user interface of the user's mobile device.

SOSA 22 provides profile settings for account and security, password reset, FAQs, and Help.

The power supply provides power to the computer 36 and the LED Indicators 30/60. It can be a battery-powered system or a charging mechanism to ensure continuous operation. The barcode scanner, either built-in or external, allows users to scan barcodes on the cards for quick identification. The scanned data is sent to the mobile app for processing and association with the corresponding card slot.

The display 24 shows card details, inventory information, and other relevant data. It can be an integrated display within the smart vault case 10, 40 or a separate device such as an iPad mini or smartphone. The display 24 may be retained in a recess 33 along an inner liner 31 of the lid 12A.

The locking mechanism secures the smart vault case 10, 40 and protects the cards from unauthorized access. Stickers with unique identifiers may be used to label and identify each card. The stickers can be scanned by the barcode scanner for automatic card recognition and association with the appropriate card slot.

The sleep/hibernate mode conserves power by turning off the LED Indicators 30/60 when the smart vault case 10, 40 is closed or idle. It ensures efficient energy usage and extends battery life. The case serial number provides a unique identifier for each graded collectible allowing for easy tracking and identification of specific cases. Camera integration enables the use of the phone's camera as a scanner for capturing barcode information, providing an alternative method for card identification and association with the corresponding slots. The components work together to create an integrated system where the mobile app, controller, LED indicators, barcode scanning, power supply, and other elements collaborate to deliver seamless card management, organization, and protection within the smart vault case 10, 40, also known as the Hobby Smart Case.

The smart vault case 10, 40 is designed to provide efficient organization, management, location tracking, and protection of graded sports cards through the following systemic steps or components. Graded sports cards are inserted into the graded card slots within the case 10. Each card is associated with a unique identifier sticker. The LED indicators next to each slot are controlled by the controller. When a card is inserted, the corresponding LED indicator lights up green, indicating the presence of a card in that slot. The power supply ensures that the controller and LED indicators are powered. It can be a rechargeable battery system or a charging mechanism.

The systemic software SOSA 22, running on a user's computing, connects to the computer 36 through the Bluetooth/Wi-Fi Module, wherein SOSA 22 allows users to manage their card inventory, track locations, and interact with the LED indicators. Users can scan the barcode on a card using the built-in or external barcode scanner. The scanned data is sent to the mobile app, which associates it with the corresponding card slot and updates the inventory. The display device shows card details, inventory information, and other relevant data. Users can view the display to access card information without relying solely on SOSA 22.

The locking mechanism ensures the smart vault case 10, 40 remains securely closed, protecting the cards from unauthorized access. The sleep/hibernate mode conserves power by turning off the LED Indicators when the smart vault case 10, 40 is closed, extending the battery life, and ensuring efficient energy usage. When the SOSA 22 is opened, the LED Indicators are activated.

The case serial number, scanned through a barcode or entered manually, identifies the specific smart vault case 10, 40 within the SOSA 22, thereby allowing users to manage multiple cases if needed.

Image-capture integration allows users to utilize the smartphone's camera as a scanner, capturing barcode information and sending it to the mobile app for processing. The components work together seamlessly to enable collectors to easily organize, track, and protect their graded sports cards. SOSA 22 provides real-time updates, inventory management, and remote control over the LED Indicators, while the smart vault case 10, 40 and its features ensure the safe storage and display of the cards.

One method of making the present invention may include the following. Design and manufacture the smart vault case 10, 40 that includes the appropriate dimensions and slots to hold the graded sports cards. Select suitable materials that are sturdy, durable, and provide adequate protection for the cards. Use manufacturing techniques such as injection molding or 3D printing to produce the Case. Design and integrate the LED indicators by determining the number and placement of LED Indicators next to each card slot. Select LED components that provide the desired brightness and color options. Design the circuitry and wiring connections to link the LED Indicators to the computer 36. The computer includes an electronic circuit board that acts as the central control unit for the LED indicators and communication with SOSA 22, wherein a microcontroller or similar device with sufficient processing power and appropriate interfaces (such as Bluetooth or Wi-Fi) incorporate power management capabilities to regulate the power supply and manage sleep/hibernate modes. A manufacturer may then integrate a power supply through determining the power requirements for the Controller and LED Indicators, and/or selecting a suitable rechargeable battery or power source that provides sufficient power for the intended operation duration. Design of the charging mechanism or port to recharge the battery is needed.

Development of SOSA 22 may include design and develop a mobile application (iOS or Android) that provides the desired functionality for managing the card inventory, tracking locations, and interacting with the LED Indicators. Such development includes Implementation of features such as barcode scanning, card identification, and communication with the controller via Bluetooth™ or Wi-Fi.

The manufacturer would then incorporate the barcode scanner after determining whether the smart vault case 10, 40 will have a built-in scanner or require an external scanner, which is followed by selecting an appropriate barcode scanning module or integrate a compatible scanner into the smart vault case 10, 40 design. Ensuring seamless communication between the scanner and SOSA 22 for quick and accurate card identification is a must.

A manufacturer may integrate the display unit by determining the size and type of display to be incorporated into the smart vault case 10, 40 (e.g., iPad mini, smartphone). Design the necessary mounting and wiring to connect the display to computer 36. Development the software interface to show card details, inventory information, and other relevant data follows.

Implementing the locking mechanism includes selecting a suitable combination lock or other security mechanism that fits the smart vault case 10, 40 design and ensuring proper functionality and ease of use.

Test and refinement includes conducting thorough testing of the smart vault case 10, 40, LED indicators, computer 36, power supply, barcode scanner, SOSA 22, and other components to ensure proper functionality and compatibility. Gathering user feedback and making necessary refinements to improve the overall performance, usability, and reliability of the smart vault case 10, 40 is required.

Manufacturing and assembly include establishing a manufacturing process to produce the case, including any required tooling or molds. Assemble the components, including the smart vault case 10, 40, LED indicators, computer 36, power supply, barcode scanner, and optional display, following the established design and assembly guidelines. By following these steps, the Hobby Smart Case can be manufactured, incorporating the necessary components and functionalities to create an efficient and user-friendly solution for organizing, managing, and protecting graded sports cards.

To make the present invention work better, additional elements that could be added include the following. Integration of a GPS module to track the location of the Case and provide geolocation data within SOSA 22. Incorporation of a temperature and humidity sensor to monitor environmental conditions and ensure optimal storage conditions for the cards. Integration of a wireless charging system to eliminate the need for physical charging ports and enhance convenience. Implementation of an RFID (Radio Frequency Identification) system to enable quick and accurate identification of cards without the need for scanning barcodes. These additional elements would enhance the functionality, convenience, and overall performance of the smart vault case 10, 40, providing collectors with an even better experience in managing their graded sports card collections.

Different types or models of smart vault cases 10, 40 can be used, as long as they provide suitable dimensions and slots to hold the graded sports cards securely. LED indicators can be positioned differently within the smart vault case 10, 40, as long as they are aligned with each card slot and effectively indicate the desired actions.

A method of using the present invention includes the following steps: Set up the smart vault case 10, 40. Ensure the smart vault case 10, 40 is fully charged or connected to a power source. Open the smart vault case 10, 40 by unlocking the combination lock or other locking mechanism. Make sure the LED indicators are turned on and ready for use. Install and launch the SOSA 22 on the user's terminal or mobile device and sign in or create an account if required. Connect SOSA 22 to the smart vault case 10, 40 via Bluetooth or Wi-Fi. Add collectibles to the smart vault case 10, 40. Place a graded sports card (slab) in one of the slots in the smart vault case 10, 40.

Optionally, affix a supply sticker with a barcode to the card for automatic identification.

Use the barcode scanner in SOSA 22 to scan the card's barcode or manually input the card's information (grade, company, etc.) if necessary. SOSA 22 will store the card's details, associate it with the specific slot in the smart vault case 10, 40, and update the inventory accordingly.

Retrieve cards from the smart vault case 10, 40 in the following manner. Open the smart vault case 10, 40 by unlocking it and lifting the lid. Use the SOSA 22 to locate the desired card by searching or browsing through the inventory. The LED Indicators next to the corresponding card slot will illuminate, guiding you to the right location. Remove the card from the smart vault case 10, 40 for further examination, display, or trading.

Update card information is facilitated by SOSA 22. If a user makes any changes to a card's information (e.g., re-grading, selling, trading), update the details in SOSA 22. The user may use the barcode scanner to scan the card's barcode or manually update the information in SOSA 22, which is configured to automatically update the card's status and keep the inventory up to date. Then close and secure the smart vault case 10, 40 by lowering the lid. The LED Indicators will turn off as the smart vault case 10, 40 enters sleep or hibernate mode. The user then locks the smart vault case 10, 40 using the combination lock or other locking mechanism to secure the cards and prevent unauthorized access.

By following these steps, collectors can efficiently use the Hobby Smart Case to organize, track, and protect their graded sports cards. The mobile app and LED Indicators work in tandem to provide a seamless experience, allowing users to easily locate, retrieve, and update information about their cards with the help of the innovative smart features.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary. It should be understood, of course, that the foregoing relates to exemplary embodiments of the invention and that modifications may be made without departing from the spirit and scope of the invention as set forth in the following claims.

What is claimed is:

1. A system for managing a plurality of collectibles that are each assigned a readable identifier, wherein the readable identifier provides a plurality of characteristics of the collectible, the system comprising:
a container including:
a plurality of collectible storage areas, each storage area configured to store one collectible of the plurality of collectibles; and
a light indicator operatively associated with each collectible storage area, so that the light indicator moves between an activated state and a deactivated state when one of the plurality of collectibles occupies and does not occupy the collectible storage area, respectively,
wherein each readable identifier is configured to be read by a mobile computing device loaded with a systemic software so that the plurality of characteristics is remotely trackable by way of the mobile computing device.

2. The system of claim 1, further comprising a lid that moves between an open condition and a closed condition, wherein the closed condition defines an enclosed space housing the plurality of collectible storage areas, and wherein a condition sensor directly connected to the container exports a condition indication to the mobile computing device by way of the systemic software, wherein the condition indication indicates the open condition and the closed condition.

3. The system of claim 2, further comprising a display unit along an inner surface of the lid, wherein the display unit is operatively associated with the systemic software to display the plurality of characteristics of each collectible after reading the readable identifier.

4. The system of claim 3, further comprising a climatic sensor configured to determine a temperature and a humidity of the enclosed space, wherein the climatic sensor is configured to export the temperature and humidity to the mobile computing device by way of the systemic software.

5. The system of claim 4, further comprising an electrical port along a body of the container, wherein the electrical port enables electrical power for each light indicator, the display unit, the climatic and condition sensors.

6. The system of claim 5, further comprising wherein the closed condition of the lid is movable between a locked condition and an unlocked condition by way of a lock mechanism.

7. The system of claim 6, further comprising a hibernate mode configured to conserve the electrical power by turning off the light indicators when the container is in the closed condition.

8. The system of claim 7, further comprising a global positioning system configured to identify a global position of the container so that a representation of the global position is representable along a user interface of the mobile computing device.

9. The system of claim 8, wherein the systemic software is configured to remotely track the plurality of characteristics of a plurality of containers.

10. The system of claim 1, wherein the systemic software is configured, upon the reading of the readable identifier, to prompt the user to add the associated collectible to a specific storage area of the plurality of storage areas.

11. A system for managing a plurality of collectibles
a container including:
a plurality of collectible storage areas, each storage area configured to store one collectible of the plurality of collectibles; and
a light indicator operatively associated with each collectible storage area, so that the light indicator moves between an activated state and a deactivated state when one of the plurality of collectibles occupies and does not occupy the collectible storage area, respectively,
a systemic software integrated with the container, wherein the systemic software is configured to receive an image of each of the plurality of collectibles and, from a systemic database, identify a plurality of characteristics associated with a respective collectible so that each collectible is remotely trackable by way of a mobile computing device on which the systemic software is loaded.

12. The system of claim 11, wherein the systemic software is configured upon the reading of the readable identifier, to prompt the mobile computing device to add collectible parameters for the collectible.

13. The system of claim 12, wherein the systemic software is configured to prompt mobile computing device to place the respective collectible in a specific storage area of the plurality of storage areas.

14. The system of claim 12, further comprising a lid that moves between an open condition and a closed condition, wherein the closed condition defines an enclosed space housing the plurality of collectible storage areas, and wherein a condition sensor directly connected to the container exports a condition indication to the mobile computing device by way of the systemic software, wherein the condition indication indicates the open condition and the closed condition.

15. The system of claim 14, further comprising a display unit along an inner surface of the lid, wherein the display unit is operatively associated with the systemic software to display the plurality of characteristics.

16. The system of claim 15, further comprising a climatic sensor configured to determine a temperature and a humidity of the enclosed space, wherein the climatic sensor is configured to export the temperature and humidity to the mobile computing device by way of the systemic software.
